(19) United States
(12) Patent Application Publication
(10) Pub. No.: US 2008/0263220 A1
(43) Pub. Date: Oct. 23, 2008

(54) IMAGE PROCESSING SYSTEM, IMAGE PROCESSING APPARATUS, IMAGE PROCESSING METHOD, AND PROGRAM

(75) Inventor: Fuminori HOMMA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/051,205

(22) Filed: Mar. 19, 2008

(30) Foreign Application Priority Data
Apr. 17, 2007 (JP) 2007-108346

(51) Int. Cl. G06F 15/16

(52) U.S. Cl. 709/231

(57) ABSTRACT

An image processing system including a plurality of servers and an image processing apparatus for integrally displaying images sent from the plurality of servers in streaming mode, wherein each of the plurality of servers includes: input means; area information receiving means; encoding means; and delivery means. The image processing apparatus includes creating means, sending means, image data receiving means, decoding means, and display means.

### CROSS REFERENCES TO RELATED APPLICATIONS

The present invention contains subject matter related to Japanese Patent Application JP 2007-108346 filed with the Japan Patent Office on Apr. 17, 2007, the entire contents of which being incorporated herein by reference.

### BACKGROUND OF THE INVENTION

1. Field of the Invention

The present invention relates to an image processing system, an image processing apparatus, an image processing method, and a program. More particularly, the invention relates to an image processing system, an image processing apparatus, an image processing method, and a program for enabling a client apparatus receiving streaming delivery to reproduce the delivered image with high quality.

2. Description of the Related Art

Recent years have witnessed rapidly increasing use of broadband network connections combined with personal computes (PC) by general households. The trend has entailed widespread acceptance of request-based information delivery services such as VOD (video on demand). In particular, the technology called streaming is currently spotlighted. Streaming involves packetizing the image data representative of an image and sending sets of these packets in streaming mode to a receiving terminal so that the terminal can reproduce the image successively in increments of packets without downloading the entire image data.

Systems have been developed to implement streaming delivery whereby contents including images and sounds output by a user's external AV apparatus such as a hard disk drive (HDD) are delivered to the user's terminal (called the client apparatus) typically made of a PC, a portable game machine or a mobile telephone over a network such as the Internet or a wireless LAN (local area network). This type of streaming delivery system allows the client apparatus to monitor the contents output by the external AV apparatus without regard to where the external AV apparatus and client apparatus are located.

The streaming delivery system of the above-outlined type has a streaming server or servers set up to connect with the external AV apparatus as well as with the client apparatus via the network. The streaming server encodes the content from the external AV apparatus in accordance with a suitable standard such as MPEG (Moving Picture Experts Group), encrypts the encoded content using appropriate encryption means such as AES (Advanced Encryption Standard), and digitally packetizes the encrypted content so as to create stream data. The stream data thus created is sent by the streaming server to the client apparatus via the network.

The client apparatus receives the stream data sent from the streaming server over the network. The received stream data is decoded typically in keeping with instructions from an application program running on the client apparatus, and the decoded data is reproduced on the client apparatus.

A method has been proposed (see Japanese Patent Laid-open No. 2001-94959) which allows a streaming server to measure its own load factor and to send information about the measured load factor to a client apparatus. The user handling the client apparatus is thus able to know the load on the streaming server and to determine how to schedule the load.

### SUMMARY OF THE INVENTION

For the above type of streaming delivery system, the qualities of the images and sounds to be delivered are proportional to line speed.

In order to enhance the qualities of delivered images and sounds where the line speed in effect is limited, it is necessary to use compression encoding such as AVC (Advanced Video Coding). However, to implement such compression encoding requires that the streaming server and client apparatus be constituted by hardware capable of performing complex calculations.

However, client apparatuses such as PCs may become increasingly sophisticated in functionality whereas streaming servers, equipment to be set up as needed, may remain stagnant in performance. In such cases, the client apparatus may not be able to exert its functionality to the full when connected with the streaming server that is inferior to, and only partially compatible with, the client apparatus in specifications.

For example, it might happen that the client apparatus can handle high-definition images of 1018 by 720 pixels and that the streaming server is incapable of high-compression encoding. In that case, the streaming server can only perform ordinary compression encoding of the images so that what is reproduced by the client apparatus are not high-definition images but merely normal definition images.

The present embodiment has been made in view of the above circumstances and provides arrangements for enabling a plurality of streaming servers to perform parallel image processing so that a client apparatus can reproduce the image with an image quality higher than what is attained by an individual streaming server.

In carrying out the present invention and according to a first embodiment thereof, there is provided an image processing system including a plurality of servers and an image processing apparatus for integrally displaying images sent from the plurality of servers in streaming mode, wherein each of the plurality of servers includes: input means; area information receiving means; encoding means; and delivery means. The input means inputs image data. The area information receiving means receives area information sent from the image processing apparatus. The encoding means encodes the image data of an area corresponding to the area information received by the area information receiving means, the encoded image data being part of the image data input by the input means. The delivery means delivers the image data encoded by the encoding means to the image processing apparatus in streaming mode. The image processing apparatus includes creating means, sending means, image data receiving means, decoding means, and display means. The creating means creates as many pieces of the area information as the number of the plurality of servers, each item of the area information being specific to one of the plurality of servers. The sending means sends each of the pieces of area information to the corresponding one of the plurality of servers. The image data receiving means receives the image data delivered by the plurality of servers. The decoding means decodes the image data received by the image data receiving means. The display means displays integrally the images resulting from the decoding by the decoding means.

The image processing system outlined above as the first invention of the present embodiment is made up of a plurality of servers and an image processing apparatus for integrally displaying images sent from the plurality of servers in streaming mode. In each of the plurality of servers, image data is first input; area information sent from the image processing apparatus is received; the image data of an area corresponding to the received area information is encoded, the encoded image data being part of the input image data; and the encoded image data is delivered to the image processing apparatus in streaming mode. In the image processing apparatus, as many pieces of the area information as the number of the plurality of servers are created, each item of the area information being specific to one of the plurality of servers; each of the pieces of area information is sent to the corresponding one of the plurality of servers; the image data delivered by the plurality of servers is received; the received image data is decoded; and the images resulting from the decoding are integrally displayed.

According to a second embodiment of the present invention, there is provided an image processing apparatus for integrally displaying images delivered by a plurality of servers in streaming mode, the image processing apparatus including: creating means; sending means; receiving means; decoding means; and display means. The creating means creates area information for denoting areas of the images to be streamed, each of the denoted image areas being destined to be encoded by the corresponding one of the plurality of servers. The sending means sendes the area information created by the creating means to each of the plurality of servers. The receiving means receives data of the image areas being streamed, the image data being delivered by the plurality of servers and encoded thereby in accordance with the area information. The decoding means decodes the image data received by the receiving means. The display means displays integrally the images resulting from the decoding by the decoding means.

According to a third embodiment of the present invention, there is provided an image processing method for use with an image processing apparatus for integrally displaying images delivered by a plurality of servers in streaming mode, the image processing procedure including the steps of: creating; sending; receiving; decoding; and displaying. The creating step creates area information for denoting areas of the images to be streamed, each of the denoted image areas being destined to be encoded by the corresponding one of the plurality of servers. The sending step sends the area information created in the creating step to each of the plurality of servers. The receiving step receives data of the image areas being streamed, the image data being delivered by the plurality of servers and encoded in accordance with the area information. The decoding step decodes the image data received in the receiving step. The displaying step displays integrally the images resulting from the decoding in the decoding step.

According to a fourth embodiment of the present invention, there is provided a program for causing a computer to perform an image processing procedure for integrally displaying images delivered by a plurality of servers in streaming mode, the image processing procedure including the steps of: creating; sending; receiving; decoding; and displaying. The creating step creates area information for denoting areas of the images to be streamed, each of the denoted image areas being destined to be encoded by the corresponding one of the plurality of servers. The sending step sends the area information created in the creating step to each of the plurality of servers. The receiving step receives data of the image areas being streamed, the image data being delivered by the plurality of servers and encoded in accordance with the area information. The decoding step decodes the image data received in the receiving step. The displaying step display integrally the images resulting from the decoding in the decoding step.

Where the image processing apparatus outlined above as the second embodiment of the invention, the image processing method as the third embodiment, or the program as the fourth embodiment is in use, area information for denoting areas of the images to be streamed is first created, each of the denoted image areas being destined to be encoded by the corresponding one of the plurality of servers; the area information thus created is sent to each of the plurality of servers. Then data of the image areas being streamed is received, the image data being delivered by the plurality of servers and encoded thereby in accordance with the area information; the received image data is decoded; and the images resulting from the decoding are integrally displayed.

According to a fifth embodiment of the present invention, there is provided an image processing apparatus as one of a plurality of image processing apparatuses for delivering image data of predetermined areas of images to a terminal apparatus in streaming mode, the terminal apparatus displaying integrally a plurality of images delivered in streaming mode, the image processing apparatus including: inputting means; area information receiving means; encoding means; and delivering means. The inputting means inputs image data of the images to be streamed. The area information receiving means receives area information sent from the terminal apparatus. The encoding means encodes the image data of the areas corresponding to the area information received by the area information receiving means, the image data representing the images input by the input means for streaming. The delivering means delivers the image data encoded by the encoding means to the terminal apparatus in streaming mode.

According to a sixth embodiment of the present invention, there is provided an image processing method for use with a plurality of image processing apparatuses for delivering image data of predetermined areas of images to a terminal apparatus in streaming mode, the terminal apparatus displaying integrally a plurality of images delivered in streaming mode, the image processing method including the steps of: inputting; receiving; encoding; and delivering. The inputting step inputs image data of the images to be streamed. The receiving step receives area information sent from the terminal apparatus. The encoding step encodes the image data of the areas corresponding to the area information received in the area information receiving step, the image data representing the images input in the inputting step for streaming. The delivering step delivers the image data encoded in the encoding step to the terminal apparatus in streaming mode.

According to a seventh embodiment of the present invention, there is provided a program for causing a computer to perform an image processing procedure for delivering image data of predetermined areas of images to a terminal apparatus in streaming mode, the terminal apparatus displaying integrally a plurality of images delivered in streaming mode, the image processing procedure including the steps of: inputting; receiving; encoding; and delivering. The inputting step inputs image data of the images to be streamed. The receiving step receives area information sent from the terminal apparatus. The encoding step encodes the image data of the areas corresponding to the area information received in the area information receiving step, the image data representing the images input in the inputting step for streaming. The delivering step delivers the image data encoded in the encoding step to the terminal apparatus in streaming mode.

Where the image processing apparatus outlined above as the fifth embodiment of the invention, the image processing method as the sixth embodiment, or the program as the seventh embodiment is in use, image data of the images to be streamed is first input; area information sent from the terminal apparatus is received; the image data of the areas corresponding to the received area information is encoded, the image data representing the images input for streaming; and the encoded image data is delivered to the terminal apparatus in streaming mode.

According to the above-outlined embodiments of the present invention, target image data delivered in streaming mode can be received in such a manner as to be reproduced with high quality.

### BRIEF DESCRIPTION OF THE DRAWINGS

Further advantages of the present invention will become apparent upon a reading of the following description and appended drawings in which:

FIG. 1 is a schematic view showing a typical configuration of a streaming delivery system according to the present embodiment;

FIG. 2 is a block diagram showing a typical structure of a streaming server included in FIG. 1;

FIG. 3 is a block diagram showing a typical structure of a client apparatus included in FIG. 1;

FIG. 4 is a flowchart of steps in which the streaming server typically operates;

FIG. 5 is a flowchart of steps in which the client apparatus typically operates;

FIG. 6 is a schematic view showing an operation screen used by the client apparatus to connect to additional streaming servers;

FIG. 7 is a schematic view explanatory of areas to be encoded by the streaming server;

FIG. 8 is a schematic view explanatory of other areas to be encoded by the streaming server; and

FIG. 9 is a block diagram showing a typical structure of a personal computer.

### DETAILED DESCRIPTION OF THE PREFERRED EMBODIMENTS

What is described below as the preferred embodiments of the present invention with reference to the accompanying drawings corresponds to the appended claims as follows: the description of the preferred embodiments basically provides specific examples supporting what is claimed. If any example of the invention described below as a preferred embodiment does not have an exactly corresponding claim, this does not means that the example in question has no relevance to the claims. Conversely, if any example of the invention depicted hereunder has a specifically corresponding claim, this does not mean that the example in question is limited to that claim or has no relevance to other claims.

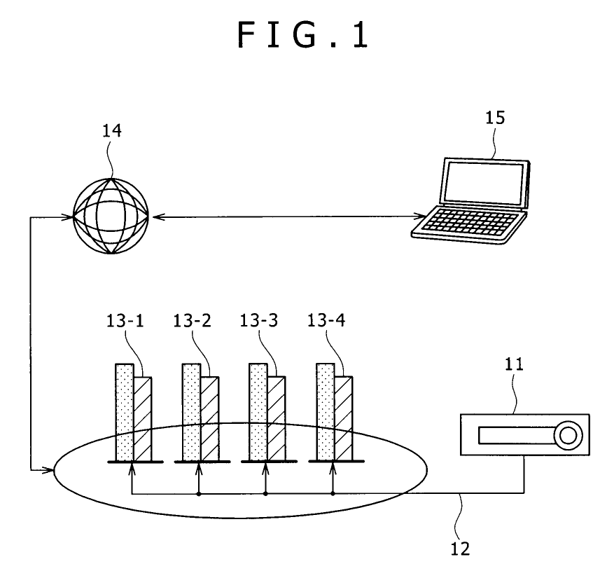

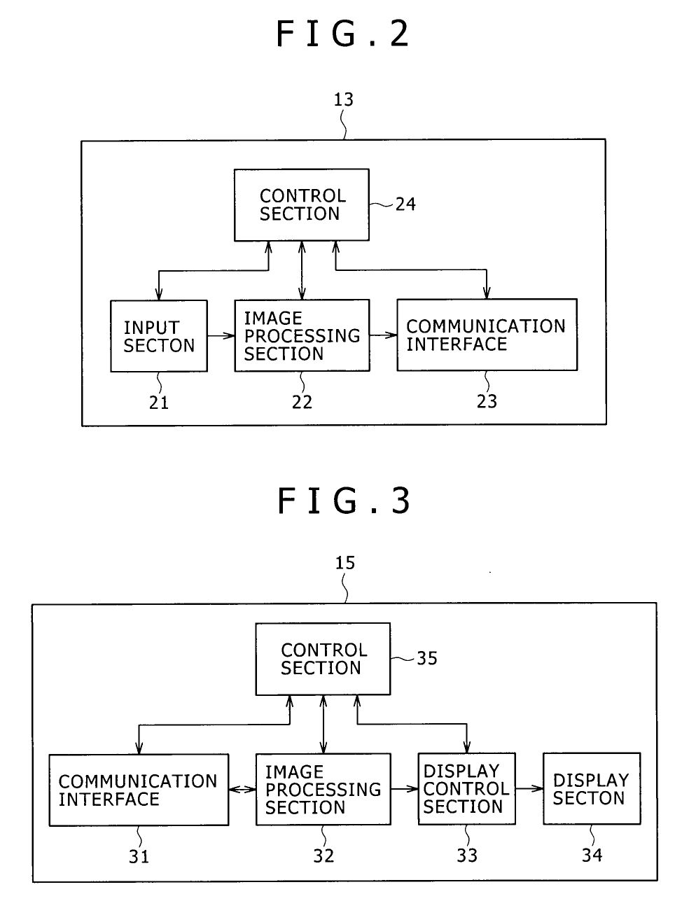

One preferred embodiment of the present invention is an image processing system including a plurality of servers (e.g., streaming servers 13-1 through 13-4 in FIG. 1) and an image processing apparatus (e.g., client apparatus 15 in FIG. 1) for integrally displaying images sent from the plurality of servers in streaming mode, wherein each of the plurality of servers includes: an input means (e.g., input section 21 in FIG. 2) configured to input image data; an area information receiving means (e.g., communication interface 23 in FIG. 2) configured to receive area information sent from the image processing apparatus; an encoding means (e.g., image processing section 22 in FIG. 2) configured to encode the image data of an area corresponding to the area information received by the area information receiving means, the encoded image data being part of the image data input by the input means; and a delivery means (e.g., communication interface 23 in FIG. 2) configured to deliver the image data encoded by the encoding means to the image processing apparatus in streaming mode; and wherein the image processing apparatus includes: a creating means (e.g., control section 35 in FIG. 3) configured to create as many pieces of the area information as the number of the plurality of servers, each item of the area information being specific to one of the plurality of servers; a sending means (e.g., communication interface 31 in FIG. 3) configured to send each of the pieces of area information to the corresponding one of the plurality of servers; an image data receiving means (e.g., communication interface 31 in FIG. 3) configured to receive the image data delivered by the plurality of servers; a decoding means (e.g., image processing section 32 in FIG. 3) configured to decode the image data received by the image data receiving means; and a display means (e.g., display control section 33 in FIG. 3) configured to display integrally the images resulting from the decoding by the decoding means.

Another preferred embodiment of the present invention is an image processing apparatus for integrally displaying images delivered by a plurality of servers in streaming mode, the image processing apparatus including: a creating means (e.g., control section 35 in FIG. 3) configured to create area information for denoting areas of the images to be streamed, each of the denoted image areas being destined to be encoded by the corresponding one of the plurality of servers; a sending means (e.g., communication interface 31 in FIG. 3) configured to send the area information created by the creating means to each of the plurality of servers; a receiving means (e.g., communication interface 31 in FIG. 3) configured to receive data of the image areas being streamed, the image data being delivered by the plurality of servers and encoded thereby in accordance with the area information; a decoding means (e.g., image processing section 32 in FIG. 3) configured to decode the image data received by the receiving means; and a display means (e.g., display control section 33 in FIG. 3) configured to display integrally the images resulting from the decoding by the decoding means.

A further preferred embodiment of the present invention is an image processing method for use with an image processing apparatus for integrally displaying images delivered by a plurality of servers in streaming mode, as well as a program for causing a computer to perform an image processing procedure for implementing the image processing method, the image processing procedure as well as the image processing method including the steps of: creating (e.g., in step S30 of FIG. 5) area information for denoting areas of the images to be streamed, each of the denoted image areas being destined to be encoded by the corresponding one of the plurality of servers; sending (e.g., in step S30 of FIG. 5) the area information created in the creating step to each of the plurality of servers; receiving (e.g., in step S24 of FIG. 5) data of the image areas being streamed, the image data being delivered by the plurality of servers and encoded thereby in accordance with the area information; decoding (e.g., in step S25 of FIG. 5) the image data received in the receiving step; and displaying (e.g., in step S26 of FIG. 5) integrally the images resulting from the decoding in the decoding step.

An even further preferred embodiment of the present invention is an image processing apparatus as one of a plurality of image processing apparatuses for delivering image data of predetermined areas of images to a terminal apparatus in streaming mode, the terminal apparatus displaying integrally a plurality of images delivered in streaming mode, the image processing apparatus including: an input means (e.g., input section 21 in FIG. 2) configured to input image data of the images to be streamed; an area information receiving means (e.g., communication interface 23 in FIG. 2) configured to receive area information sent from the terminal apparatus; an encoding means (e.g., image processing section 22 in FIG. 2) configured to encode the image data of the areas corresponding to the area information received by the area information receiving means, the image data representing the images input by the input means for streaming; and a delivery means (e.g., communication interface 23 in FIG. 2) configured to deliver the image data encoded by the encoding means to the terminal apparatus in streaming mode.

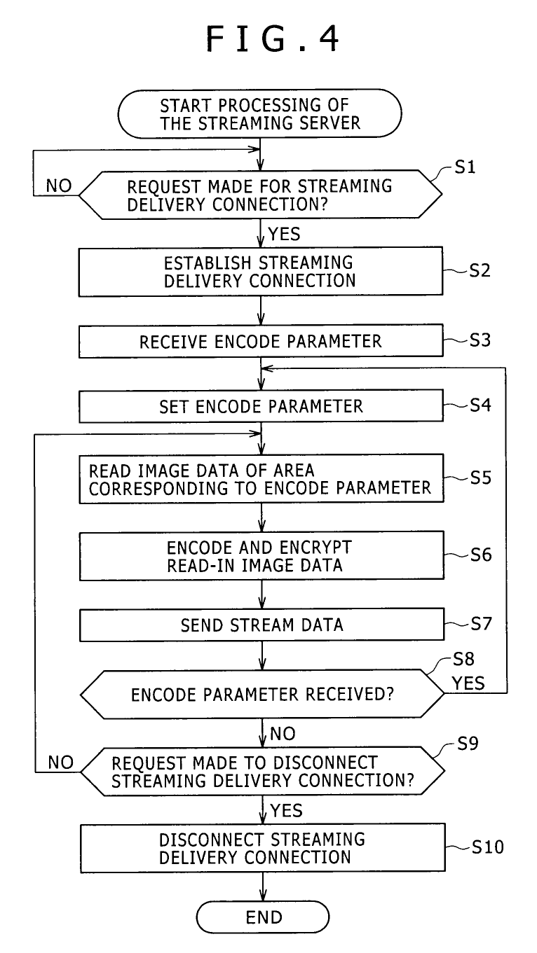

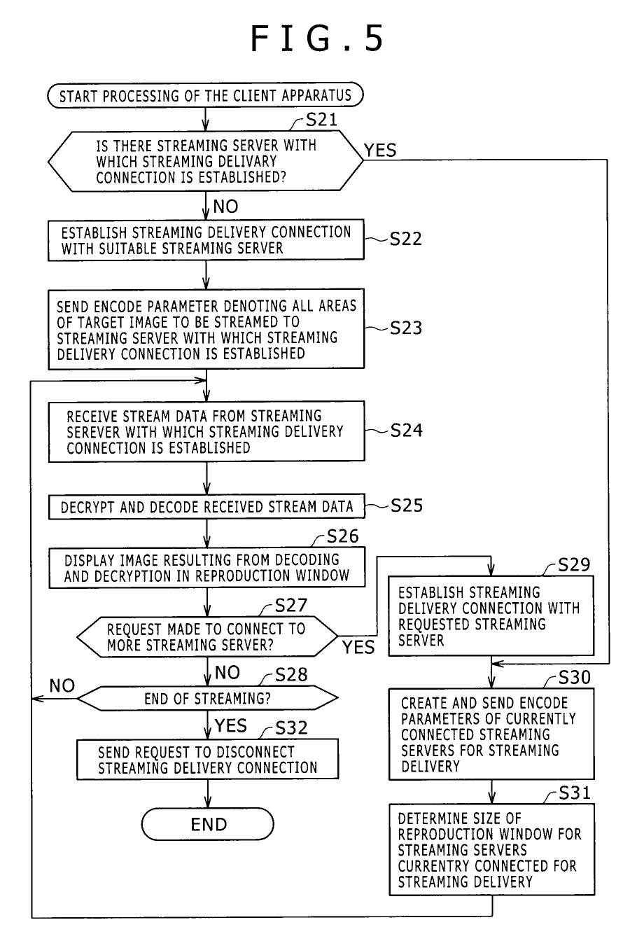

A still further preferred embodiment of the present invention is an image processing method for use with a plurality of image processing apparatuses for delivering image data of predetermined areas of images to a terminal apparatus in streaming mode, the terminal apparatus displaying integrally a plurality of images delivered in streaming mode, as well as a program for causing a computer to perform an image processing procedure for implementing the image processing method, the image processing procedure as well as the image processing method including the steps of: inputting (e.g., through input section 21 in FIG. 2) image data of the images to be streamed; receiving (e.g., in step S3 or S8 of FIG. 4) area information sent from the terminal apparatus; encoding (e.g., in step S6 of FIG. 4) the image data of the areas corresponding to the area information received in the area information receiving step, the image data representing the images input in the inputting step for streaming; and delivering (e.g., in step S7 of FIG. 4) the image data encoded in the encoding step to the terminal apparatus in streaming mode.

FIG. 1 schematically shows a typical configuration of a streaming delivery system according to the present embodiment.

In this system, an external AV apparatus 11 is a hard disk drive (HDD) recorder or the like. The apparatus 11 outputs AV signals representing the content data of images and sounds illustratively to four streaming servers 13-1 through 13-4 using a composite signal over an AV cable 12.

The AV cable is branched into the four streaming servers 13-1 through 13-4 so that the AV signal output by the external AV apparatus 11 will be commonly input to the servers.

The four streaming servers 13-1 through 13-4 (simply called the streaming server 13 if there is no need to distinguish therebetween) are connected to the external AV apparatus 11 through the AV cable 12. These servers are also designed to establish connection with a network 14 such as the Internet or a wireless LAN for transmission of stream data to a client apparatus 15.

The streaming server 13 receives the AV signal coming from the external AV apparatus 11 over the AV cable 12.

When connected with the client apparatus 15 for stream data transmission, the streaming server 13 illustratively resorts to a suitable standard such as MPEG to encode the image data of an image area corresponding to an encode parameter sent by the client apparatus 15 with regard to, say, the target image data of one frame (i.e., image data to be streamed) represented by the received AV signal. The streaming server 13 proceeds to encrypt the encoded data using appropriate encryption means such as AES and digitally packetize the resulting data into stream data. The stream data thus created is sent by the streaming server 13 to the client apparatus 15 via the network 14.

The client apparatus 15 is connected to the network 14 in a manner ready to establish connection with the streaming server 13 for receiving stream data therefrom.

In keeping with the number of streaming servers 13 with which connections are established to receive stream data, the client apparatus 15 determines the area of the stream image to be encoded by each streaming server 13. An encode parameter designating the area of interest is sent by the client apparatus 15 to the corresponding streaming server 13.

The client apparatus 15 receives one item of stream data from each of the streaming servers 13 with which connections are established for stream data reception. The received items of stream data are decoded according to the instructions from an application program running on the client apparatus 15. The images resulting from the decoding are then displayed integrally by the client apparatus 15.

FIG. 2 shows a typical structure of the streaming server 13 revealing its major components for image processing.

An input section 21 is connected to the AV cable 12. Given the AV signal from the external AV apparatus 11, the input section 21 converts the received signal into digital form and supplies the digital signal to an image processing section 22.

The image processing section 22 is supplied with AV data (e.g., image data of one frame) from the input section 21. Of the supplied data, the image data of the area corresponding to the encode parameter sent from the client 15 via a control section 24 is encoded by the image processing section 21 in accordance with a suitable standard such as MPEG. The image processing section 22 encrypts the encoded data using suitable encryption means such as AES and digitally packetizing the resulting data into stream data. The stream data thus created is forwarded to a communication interface 23.

The communication interface 23 is set up in a manner ready to establish connection with the network 14 for sending stream data to the client apparatus 15. When connected with the client apparatus 15 via the network 14, the communication interface 23 receives the encode parameter coming from the client apparatus 15 and forwards the received parameter to the control section 24. The communication interface 23 further sends the stream data supplied by the image processing section 22 to the client apparatus 15 that is connected for stream data transmission via the network 14.

The control section 24 is made up of a CPU (central processing unit), a ROM (read only memory), and a RAM (random access memory). These units combine to control the relevant components of the server.

FIG. 3 shows a typical structure of the client apparatus 15 revealing its major components for image processing.

A communication interface 31 is connected to the network 14 in a manner ready to establish connection with the streaming server 13 for stream data reception. Given an encode parameter from a control section 35, the communication interface 31 forwards the parameter to the streaming server 13. The communication interface 31 also receives stream data from the streaming server 13 over the network 14 and supplies the received data to an image processing section 32.

The image processing section 32 determines the areas of the image to be encoded for streaming in accordance with the number of streaming servers 13 with which connections are established for stream data reception, the encoding being performed by the streaming servers 13. The image processing section 32 proceeds to supply the communication interface 31 with the encode parameters for designating the determined areas.

In the description that follows, the connection established to send stream data and the connection to receive stream data will be commonly referred to as the streaming delivery connection if there is no need to distinguish between the two kinds of connection.

The image processing section 32 decodes the stream data sent from the streaming server 13 through the communication interface 31. The images resulting from the decoding are integrated by the image processing section 32 before being fed to a display control section 33.

The display control section 33 causes a display section 34 to display the images reflecting the image data supplied by the image processing section 32.

The control section 35 is made up of a CPU, a ROM, and a RAM. These units combine to control the relevant components of the client apparatus.

How the streaming server 13 works will now be described by referring to the flowchart of FIG. 4.

In step S1, the control section 24 of the streaming server 13 waits for a request to be sent by the client apparatus 15 for a streaming delivery connection through the communication interface 23. Upon receipt of the request, step S2 is reached. In step S2, the control section 24 controls the communication interface 23 to carry out predetermined processes including authentication in cooperation with the client apparatus 15 so as to establish the streaming delivery connection with the apparatus 15.

When the streaming delivery connection is established with the client apparatus 15, step S3 is reached. In step S3, the communication interface 23 of the streaming server 13 receives an encode parameter from the client apparatus 15 and forwards the received parameter to the control section 24.

In step S4, the control section 24 sets the encode parameter coming from the communication interface 23 for the image processing section 22. In steps S5 and S6, the control section 24 causes the image processing section 22 to perform encoding.

More specifically, in step S5, the image processing section 22 reads the image data of an image area corresponding to the set encode parameter, the area being part of one frame of image data coming from the input section 21. In step S6, the image processing section 22 encodes the read-in image data in accordance with a suitable standard such as MPEG, encrypts the encoded data using appropriate encryption means such as AES, and digitally packetizes the resulting data into stream data.

In step S7, the image processing section 22 supplies the communication interface 23 with the stream data derived from the above-described image processing. In turn, the communication interface 23 sends the stream data supplied by the image processing section 23 to the client apparatus 15 over the network 14.

In step S8, the control section 24 controlling the communication interface 23 checks to determine whether a new encode parameter is received. If any new encode is not found to be received, i.e., if the streaming based on the most-recently received encode parameter is still in progress, then the control section 24 goes to step S9. In step S9, the control section 24 controlling the communication interface 23 checks to determine whether a request to disconnect the streaming delivery connection is received. If no such request is found to be received, then step S5 is reached again and the subsequent steps are repeated. That is, the streaming based on the last received encode parameter is allowed to continue.

If in step S8 a new encode parameter is found to be received, then step S4 is reached again. In step S4, the newly received encode parameter is set for the image processing section 22. Thereafter, step S5 and subsequent steps are reached and carried out as described above.

If in step S9 the request to disconnect the streaming delivery connection is found to be received, then step S10 is reached. In step S10, the control section 24 controls the communication interface 23 to disconnect the streaming delivery connection established in step S2, thereby bringing the streaming process to an end.

How the client apparatus 15 works during image processing will now be described by referring to the flowchart of FIG. 5.

The processing of the client apparatus 15 is started when an operation section, not shown, of the client apparatus 15 is operated by the user to input a streaming start command to the control section 35. In step S21, the control section 35 checks to determine whether there is any streaming server 13 with which the streaming delivery connection is already established. If no such streaming server 13 is found to exist in step S21, then step S22 is reached.

In step S22, the control section 35 activates a thread of the application program for reproducing stream data. The control section 35 controls the communication interface 31 to perform predetermined processes including authentication in cooperation with one streaming server 13 so as to establish the streaming delivery connection with that server 13.

The processing under control of the control section 35 will be executed henceforth by the thread activated earlier.

In step S23, the control section 35 sets the size of a reproduction window illustratively as the screen size of the display section 34. At the same time, the control section 35 controls the communication interface 31 to send the encode parameter designating the entire area for the image being streamed to the streaming server 13 with which the streaming delivery connection was established in step S22.

In step S24, the communication interface 31 receives the stream data from the streaming server 13 with which the streaming delivery connection is being established. The received data is forwarded from the communication interface 31 to the image processing section 32.

In step S25, the control section 35 controls the image processing section 32 to decrypt and decode the stream data coming from the communication interface 31.

In step S26, the control section 35 controls the display control section 33 to display the decoded image onto the reproduction window (the entire screen of the display section 34 in this case).

In step S27, the control section 35 checks to determine whether the operation section, not shown, is operated to request a connection with additional streaming servers 13. If no such request is found to be made, then step S28 is reached. In step S28, the control section 35 checks to determine whether a streaming end command is input.

If in step S28 the streaming end command is not found to be input, then step S24 is reached again and the subsequent steps are repeated.

As described, if there is no streaming server 13 with which a streaming delivery connection is established at the start of streaming, then the streaming delivery connection is established with one streaming server 13. The image corresponding to the stream data sent from that streaming server 13 is then displayed.

In the above case, the target image to be streamed is encoded and otherwise processed by the streaming server 13 in question. Depending on the number of processible pixels, the streaming server 13 thins out the target image before proceeding with the encoding and other processing so as to create the stream data.

If in step S27 a request is found to be made for the connection with an additional streaming server 13, then control is passed on to step S29.

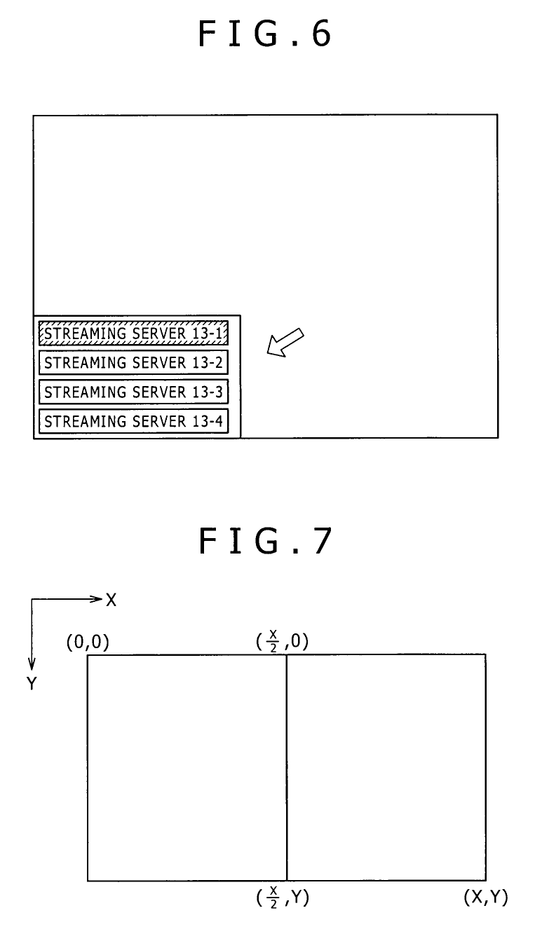

The display section 34 of the client apparatus 15 displays an operation screen such as one shown in FIG. 6, the screen being designed to let the user select a streaming server 13 with which to establish a streaming delivery connection. An additional streaming server 13 to be connected may be designated by using a pointer to select the displayed indication of the server 13 of interest or by drag-and-dropping the indication selectively into a suitable field on the screen.

The indication of the streaming server 13 shown shaded in FIG. 6 signifies that the streaming delivery connection is currently established with the streaming server 13 represented by the indication in question.

In step S29 back in FIG. 5, the control section 35 activates an additional reproduction thread that controls the communication interface 31 to carry out predetermined processes including authentication in cooperation with the streaming server 13 requested for the additional connection, whereby the streaming delivery connection is established with the client apparatus 15 of interest.

Step 30 is reached if in step S29 a streaming delivery connection is established with the additional streaming server or if in step S21 there is found a streaming server with which the streaming delivery connection is currently established. In step S30, typically in keeping with the number of streaming servers 13 currently connected for streaming delivery, the control section 35 determines the areas of the stream image to be encoded by the streaming servers 13 involved, and creates encode parameters for designating the areas in question. The control section 35 controls the communication interface 31 to send the created encode parameters to the streaming servers 13 with which the streaming delivery connections are currently established.

Illustratively, suppose that the image size corresponding to the AV signal (i.e., entire area for the target image to be streamed) supplied by the external AV apparatus 11 to the streaming server 13 is defined as X×Y as shown in FIG. 7, and that streaming delivery connections are currently established with two streaming servers 13-1 and 13-2. In that case, the area to be encoded by the streaming server 13-1 may be set to range from the point of origin (0, 0) to the destination (X/2, Y), and an encode parameter designating that area is sent to the streaming server 13-1. The area to be encoded by the streaming server 13-2 may be set to range from the point of origin (X/2, 0) to the destination (X, Y), and an encode parameter designating that area is sent to the streaming server 13-2.

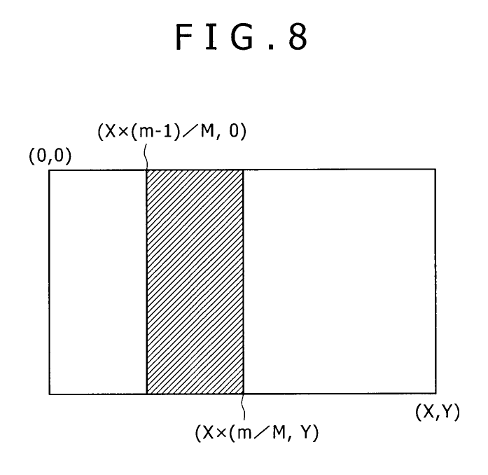

The areas to be encoded are determined typically according to the encoding performance of the streaming servers 13 involved. If the entire area is to be divided vertically into equal portions, and if the streaming delivery connections are currently established with as many as M streaming servers 13, then the area to be encoded by the m-th streaming server 13 is generally defined as one which ranges from the point of origin (X×(m−1)/M, 0) to the destination (X×m/M, Y) as shown in FIG. 8.

In step S31 back in FIG. 5, the control section 35 determines the size of the reproduction window activated by each thread of the application in accordance with the number of streaming servers 13 with which the streaming delivery connections are currently established. As with the areas to be encoded, the reproduction window on the display section 34 is divided into as many portions as the number of streaming servers 13 currently connected for streaming delivery.

Thereafter, step S24 is reached again and the subsequent steps are repeated. That is, each item of stream data sent by each streaming server 13 with which the streaming delivery connection is established is received in step S24.

In step S25, each item of stream data received earlier is decoded.

In step S26, the images resulting from the decoding are displayed in the suitably divided portions of the reproduction window.

As described, in keeping with the number of streaming servers 13 currently connected for streaming delivery, each area to be encoded by each of the streaming servers 13 involved is determined. Part of the target image to be streamed is thus encoded by each streaming server 13. The images resulting from the encoding of the divided image area are integrally displayed. This enables the client apparatus 15 to display high-quality images reflecting its image processing capacity even if the image processing capacity of each individual streaming server 13 is inferior to that of the client apparatus 15.

Illustratively, suppose that the target image to be streamed is a high-definition image (1080 by 720 pixels), that the client apparatus 15 has an image processing capability high enough to display high-definition videos, and that the streaming server 13 has the image processing capability to display images of up to 400 by 300 pixels. In that case, the client apparatus 15 can reproduce high-definition videos in streaming mode if there are provided seven streaming servers 13 each encoding part of the target image (1080 by 720 pixels) to be streamed.

The larger the number of additional streaming servers 13 connected, the narrower the area to be encoded by each of the streaming servers 13 added. For that reason, the user may purchase pre-owned streaming servers 13 of lesser image processing performance and install them additionally as needed. In this manner, the user can view high-definition videos on the client apparatus 15 without having to purchase a high-specification streaming server 13.

If in step S28 a streaming end command is found to be input, then step S32 is reached. In step S32, the control section 35 controls the communication interface 31 to send to the currently connected streaming server 13 a request to disconnect the streaming delivery connection. This brings the processing to an end.

In the foregoing description, four streaming servers 13 were assumed to be configured. Alternatively, any suitable number of streaming servers 13 may be utilized depending on the performance of the client apparatus 15 and that of each streaming server 13.

The streaming servers 13 involved are assumed to have clocks indicating the same time. The clocks allow the streaming servers 13 to operate in synchronous fashion.

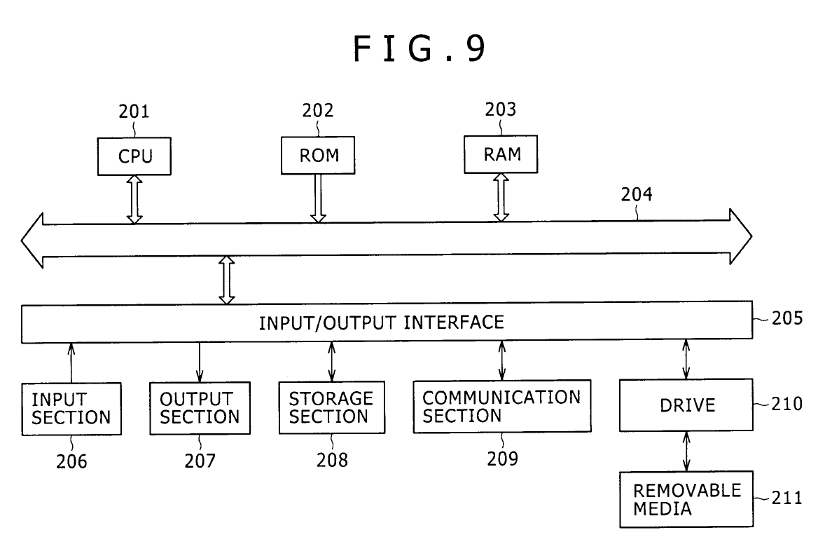

FIG. 9 is a block diagram showing a typical hardware structure of a personal computer capable of executing the above-described steps and processes in the form of programs.

In the computer, a CPU (central processing unit) 201, a ROM (read only memory) 202, and a RAM (random access memory) 203 are interconnected by a bus 204.

The bus 204 is also connected to an input/output interface 205. The input/output interface 205 is connected with an input section 206, an output section 207, a storage section 280, a communication section 209, and a drive 210. The input section 206 is typically made up of a keyboard, a mouse, and a microphone. The output section 207 is formed illustratively by a display unit and speakers. The storage section 208 is usually constituted by a hard disk drive or some other suitable nonvolatile memory. The communication section 209 typically functions as a network interface. A piece of removable media 211 such as magnetic disks, optical disks, magneto-optical disks or semiconductor memories is attached to and driven by the drive 210.

In the computer structured as described above, the CPU 201 may load relevant programs from the storage section 208 into the RAM 203 through the input/output interface 205 and bus 204, before executing the loaded programs. The above-described series of steps and processes may be carried out the CPU 201 executing the suitable programs.

The programs to be executed by the CPU 201 are typically offered to the user as recorded on the removable media 211 serving as package media such as magnetic disks (including flexible disks), optical disks (including CD-ROM (compact disc read-only memory) and DVD (digital versatile disc)), magneto-optical disks, or semiconductor memory. The programs may also be offered to the user via wired or wireless communication media such as local area networks, the Internet, and digital satellite broadcasting networks.

With an appropriate piece of removable media 211 attached to the drive 210, the programs may be installed from the attached medium into the storage section 208 through the input/output interface 205. Alternatively, the programs may be received by the communication section 209 via wired or wireless communication media before being installed into the storage section 208. As another alternative, the programs may be preinstalled in the ROM 202 or storage section 208.

In this specification, the programs for execution by the computer may be not only programs that are to be carried out in the depicted sequence (i.e., chronologically) but also programs which may be performed in a suitably timed manner such as when called up.

It should be understood by those skilled in the art that various modifications, combinations, sub-combinations and alterations may occur depending on design requirements and other factor in so far as they are within the scope of the appended claims or the equivalents thereof.

What is claimed is:

1. An image processing system comprising a plurality of servers and an image processing apparatus for integrally displaying images sent from said plurality of servers in streaming mode, wherein
each of said plurality of servers includes
input means for inputting image data,
area information receiving means for receiving area information sent from said image processing apparatus,
encoding means for encoding the image data of an area corresponding to said area information received by said area information receiving means, the encoded image data being part of said image data input by said input means, and
delivery means for delivering the image data encoded by said encoding means to said image processing apparatus in streaming mode,
said image processing apparatus includes
creating means for creating as many pieces of said area information as the number of said plurality of servers, each item of said area information being specific to one of said plurality of servers,
sending means for sending each of said pieces of area information to the corresponding one of said plurality of servers,
image data receiving means for receiving said image data delivered by said plurality of servers,
decoding means for decoding said image data received by said image data receiving means, and
display means for displaying integrally the images resulting from the decoding by said decoding means.

2. An image processing apparatus for integrally displaying images delivered by a plurality of servers in streaming mode, said image processing apparatus comprising:
creating means for creating area information for denoting areas of the images to be streamed, each of the denoted image areas being destined to be encoded by the corresponding one of said plurality of servers;
sending means for sending said area information created by said creating means to each of said plurality of servers;
receiving means for receiving data of the image areas being streamed, the image data being delivered by said plurality of servers and encoded in accordance with said area information;
decoding means for decoding said image data received by said receiving means; and
display means for displaying integrally the images resulting from the decoding by said decoding means.

3. An image processing method for use with an image processing apparatus for integrally displaying images delivered by a plurality of servers in streaming mode, said image processing method comprising the steps of:
creating area information for denoting areas of the images to be streamed, each of the denoted image areas being destined to be encoded by the corresponding one of said plurality of servers;
sending said area information created in said creating step to each of said plurality of servers;
receiving data of the image areas being streamed, the image data being delivered by said plurality of servers and encoded in accordance with said area information;
decoding said image data received in said receiving step; and
displaying integrally the images resulting from the decoding in said decoding step.

4. A program for causing a computer to perform an image processing procedure for integrally displaying images delivered by a plurality of servers in streaming mode, said image processing procedure comprising the steps of:
creating area information for denoting areas of the images to be streamed, each of the denoted image areas being destined to be encoded by the corresponding one of said plurality of servers;
sending said area information created in said creating step to each of said plurality of servers;
receiving data of the image areas being streamed, the image data being delivered by said plurality of servers and encoded thereby in accordance with said area information;
decoding said image data received in said receiving step; and
displaying integrally the images resulting from the decoding in said decoding step.

5. An image processing apparatus as one of a plurality of image processing apparatuses for delivering image data of predetermined areas of images to a terminal apparatus in streaming mode, said terminal apparatus displaying integrally a plurality of images delivered in streaming mode, said image processing apparatus comprising:
inputting means for inputting image data of the images to be streamed;
area information receiving means for receiving area information sent from said terminal apparatus;
encoding means for encoding the image data of the areas corresponding to said area information received by said area information receiving means, said image data representing the images input by said input means for streaming; and
delivering means for delivering said image data encoded by said encoding means to said terminal apparatus in streaming mode.

6. An image processing method for use with a plurality of image processing apparatuses for delivering image data of predetermined areas of images to a terminal apparatus in streaming mode, said terminal apparatus displaying integrally a plurality of images delivered in streaming mode, said image processing method comprising the steps of:
inputting image data of the images to be streamed;
receiving area information sent from said terminal apparatus;
encoding the image data of the areas corresponding to said area information received in said area information receiving step, said image data representing the images input in said inputting step for streaming; and
delivering said image data encoded in said encoding step to said terminal apparatus in streaming mode.

7. A program for causing a computer to perform an image processing procedure for delivering image data of predetermined areas of images to a terminal apparatus in streaming mode, said terminal apparatus displaying integrally a plurality of images delivered in streaming mode, said image processing procedure comprising the steps of:
inputting image data of the images to be streamed;
receiving area information sent from said terminal apparatus;
encoding the image data of the areas corresponding to said area information received in said area information receiving step, said image data representing the images input in said inputting step for streaming; and
delivering said image data encoded in said encoding step to said terminal apparatus in streaming mode.

8. An image processing apparatus for integrally displaying images delivered by a plurality of servers in streaming mode, said image processing apparatus comprising:
a creating unit configured to create area information for denoting areas of the images to be streamed, each of the denoted image areas being destined to be encoded by the corresponding one of said plurality of servers;
a sending unit configured to send said area information created by said creating unit to each of said plurality of servers;
a receiving unit configured to receive data of the image areas being streamed, the image data being delivered by said plurality of servers and encoded thereby in accordance with said area information;
a decoding unit configured to decode said image data received by said receiving unit; and
a display unit configured to display integrally the images resulting from the decoding by said decoding unit.

9. An image processing apparatus as one of a plurality of image processing apparatuses for delivering image data of predetermined areas of images to a terminal apparatus in streaming mode, said terminal apparatus displaying integrally a plurality of images delivered in streaming mode, said image processing apparatus comprising:
an input unit configured to input image data of the images to be streamed;
an area information receiving unit configured to receive area information sent from said terminal apparatus;
an encoding unit configured to encode the image data of the areas corresponding to said area information received by said area information receiving unit, said image data representing the images input by said input unit for streaming; and
a delivery unit configured to deliver said image data encoded by said encoding unit to said terminal apparatus in streaming mode.
